(19) United States
(12) Patent Application Publication
(10) Pub. No.: US 2019/0171149 A1
(43) Pub. Date: Jun. 6, 2019

(54) RECORDING MATERIAL DISCRIMINATING APPARATUS, IMAGE FORMING APPARATUS, AND METHOD OF CONTROLLING RECORDING MATERIAL DISCRIMINATING APPARATUS

(71) Applicant: KONICA MINOLTA, INC., Tokyo (JP)

(72) Inventors: Takahiro Tsujimoto, Toyokawa-shi (JP); Takeshi Tamada, Toyohashi-shi (JP); Hiroaki Takatsu, Nishio-shi (JP); Tianhua Xu, Toyokawa-shi (JP)

(73) Assignee: KONICA MINOLTA, INC., Tokyo (JP)

(21) Appl. No.: 16/181,610

(22) Filed: Nov. 6, 2018

(30) Foreign Application Priority Data
Dec. 1, 2017 (JP) 2017-231657

(51) Int. Cl. G03G 15/00

(52) U.S. Cl. CPC G03G 15/5029

(57) ABSTRACT

A recording material discriminating apparatus includes: a hardware processor that: detects a physical property of a recording material in different ways; and when transmittance of the recording material is within a first range, discriminates a type of the recording material by using a detection result from the hardware processor, and when the transmittance of the recording material is within a second range different from the first range, discriminates the type of the recording material by using a detection result from the hardware processor.

The entire disclosure of Japanese patent Application No. 2017-231657, filed on Dec. 1, 2017, is incorporated herein by reference in its entirety.

### BACKGROUND

### Technological Field

The present invention relates to a recording material discriminating apparatus, an image forming apparatus, and a method of controlling the recording material discriminating apparatus. More specifically, the invention relates to a recording material discriminating apparatus that discriminates the type of a recording material, an image forming apparatus, and a method of controlling the recording material discriminating apparatus.

### Description of the Related art

Electrophotographic image forming apparatuses include multi function peripherals (MPs), facsimile apparatuses, copying machines, and printers. The MFPs have a scanner function, a facsimile function, a copying function, a printer function, a data communication function, and a server function.

In a conventional image forming apparatus, a user needs to set the type of a recording material based on, for example, the basis weight of the recording material through an operation panel or a personal computer (PC) when replenishing a cassette of the image forming apparatus with recording materials. The image forming apparatus forms a high-quality image by selecting a transportation speed and a fixing temperature that are optimum for the set type of recording material. Unfortunately, difficulty and troublesomeness in a method of setting the type of the recording material may cause inaccurate setting of the type of the recording material, leading to paper jamming and deterioration in the formed image.

Thus, for example, JP 2009-75370 A and JP 2009-46217 A propose recording material discriminating apparatuses (media sensors) that reduce burdens on users who set the type of the recording material by automatically detecting the physical property of the recording material to be printed and accordingly discriminating the type of the recording material.

JP 2009-75370 A discloses a technique for detecting, for example, paper thickness, plain paper, thin paper or gloss paper by detecting a reflection amount (surface property of a recording material) and a transmission amount (thickness of the recording material) of light with a plurality of optical sensors.

JP 2009-46217 A discloses an image forming apparatus having a function of detecting back paper. The image forming apparatus is provided with image detecting unit in a reverse passage. The image detecting unit detects whether a back surface of a recording paper has already been printed based on an amount of light that is applied onto and reflected by the back surface.

Techniques in, for example, JP 2009-75370 A and JP 2009-46217 use only optical sensors, which are detection sensors using light. Unfortunately, the optical sensors cannot detect, for example, back paper and label paper, and the accuracy in discriminating the type of a recording material is low. Users of image forming apparatuses desire printing on back paper and label paper.

### SUMMARY

The invention is to solve the above-described problems, and an object thereof is to provide a recording material discriminating apparatus that can improve the accuracy in discriminating the type of a recording material, an image forming apparatus, and a method of controlling the recording material discriminating apparatus.

To achieve the abovementioned object, according to an aspect of the present invention, a recording material discriminating apparatus reflecting one aspect of the present invention comprises: a hardware processor that: detects a physical property of a recording material in different ways; and when transmittance of the recording material is within a first range, discriminates a type of the recording material by using a detection result from the hardware processor, and when the transmittance of the recording material is within a second range different from the first range, discriminates the type of the recording material by using a detection result from the hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a cross-sectional view schematically illustrating a configuration of an image forming apparatus according to one embodiment of the invention;

FIG. 2 is a cross-sectional view illustrating partial configurations of optical, ultrasonic, and paper thickness sensors in one embodiment of the invention, and taken along an xz plane at a first position in a y-axis direction;

FIG. 3 is a cross-sectional view illustrating the partial configurations of the optical, ultrasonic, and paper thickness sensors in one embodiment of the invention, and taken along the xz plane at a second position in the y-axis direction;

FIG. 4 illustrates the partial configurations of the optical, ultrasonic, and paper thickness sensors in one embodiment of the invention, and the vicinity of a substrate as seen in a direction, from positive to negative, of an x-axis;

FIG. 5 illustrates the partial configurations of the optical, ultrasonic, and paper thickness sensors in one embodiment of the invention, and the vicinity of the substrate as seen in a direction, from positive to negative, of a z-axis;

FIG. 6 is a perspective view illustrating the partial configurations of the optical, ultrasonic, and paper thickness sensors in one embodiment of the invention, and illustrating the vicinity of a resist roller;

FIG. 7 illustrates a method of detecting the basis weight of a recording material with the optical sensor in one embodiment of the invention;

FIGS. 8A to 8C schematically illustrate various printing patterns of back paper;

FIG. 9 illustrates a method of detecting the basis weight of the recording material with the ultrasonic sensor in one embodiment of the invention;

FIG. 10 illustrates a method of detecting the basis weight of the recording material with the paper thickness sensor in one embodiment of the invention;

FIGS. 11A and 11B schematically illustrate information output by a sensor in one embodiment of the invention;

FIG. 12 is a graph illustrating the relation between the transmittance of light that is transmitted through the recording material detected by the optical sensor in one embodiment of the invention and the actual basis weight of the recording material;

FIG. 13 illustrates the relation between a voltage value output by the ultrasonic sensor in one embodiment of the invention and the actual basis weight of the recording material;

FIG. 14 is a graph illustrating the relation between the basis weight of the recording material detected by the paper thickness sensor in one embodiment of the invention and the actual basis weight of the recording material;

FIG. 15 illustrates the detection accuracy of each of the optical, ultrasonic, and paper thickness sensors for various recording materials;

FIG. 16 illustrates a combination of the transmittance of the recording material in one embodiment of the invention and the sensors used for basis weight detection;

FIG. 17 illustrates a method of discriminating the type of the recording material in one embodiment of the invention;

FIG. 18 schematically illustrates a setting table in one embodiment of the invention;

FIG. 19 is a first part of a flowchart illustrating an operation of the image forming apparatus in one embodiment of the invention; and

FIG. 20 is a second part of the flowchart illustrating the operation of the image forming apparatus in one embodiment of the invention.

### DETAILED DESCRIPTION OF EMBODIMENTS

Hereinafter, one or more embodiments of the present invention will be described with reference to the drawings. However, the scope of the invention is not limited to the disclosed embodiments.

In the following embodiment, a recording material discriminating apparatus mounted on an image forming apparatus will be described. Examples of the image forming apparatus include, for example, MFPs, printers, copying machines, and facsimiles. In addition, the recording material discriminating apparatus may be mounted on an apparatus other than an image forming apparatus, such as a storage apparatus for recording materials and a postprocessing apparatus.

Note that, in the drawings, an x-axis direction corresponds to a width direction of an image forming apparatus 1 as seen from the front, a y-axis direction corresponds to a depth direction, and a z-axis direction indicates a height direction. X-, y-, and z-axes are orthogonal to each other.

### Configuration of Image Forming Apparatus

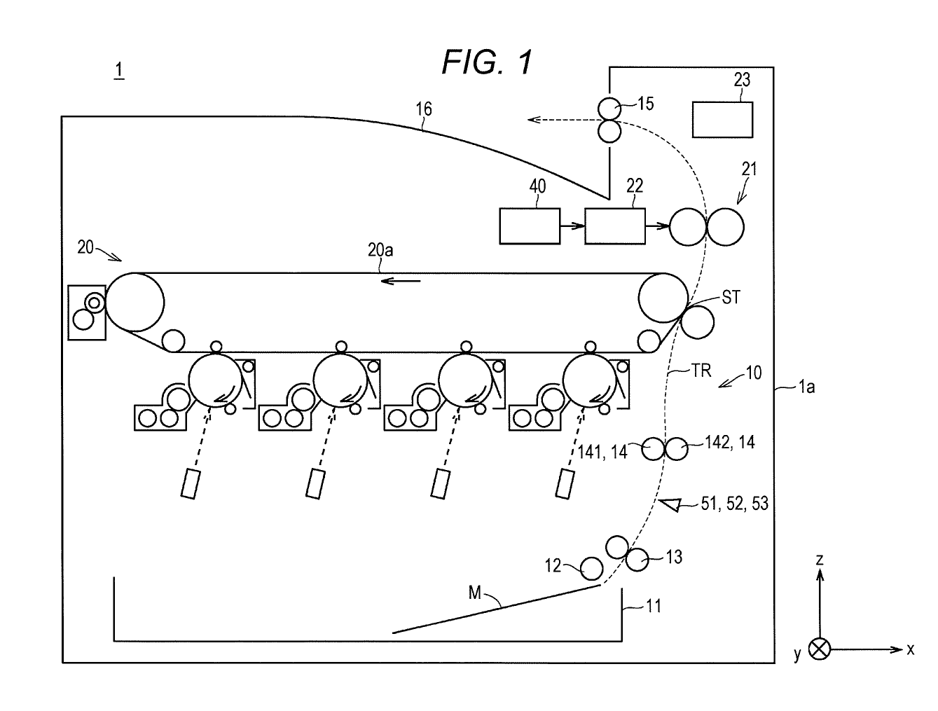

FIG. 1 is a cross-sectional view schematically illustrating a configuration of the image forming apparatus 1 in one embodiment of the invention.

Referring to FIG. 1, the image forming apparatus 1 in the embodiment (one example of recording material property detecting apparatuses) discriminates the type of a recording material, and performs printing on the recording material under a printing condition according to the discriminated type of the recording material. The image forming apparatus 1 mainly includes a recording material transporter 10, a toner image former 20 (one example of printers), a fixing apparatus 21, a power supply 22, an operation input 23 (one example of receptors), a controller 40, an optical sensor 51 (one example of outputters), an ultrasonic sensor 52 and a paper thickness sensor 53.

The recording material transporter 10 transports a recording material M along a transportation route TR. The recording material transporter 10 includes a paper feeding tray 11 (one example of storages), a paper feeding roller 12, a transportation roller 13, a resist roller 14, a paper discharging roller 15, and a paper discharging tray 16. The paper feeding tray 11 carries and stores the recording material M used for forming an image. A plurality of paper feeding trays 11 may be used. The paper feeding roller 12 is provided between the paper feeding tray 11 and the transportation route TR. The transportation roller 13 and the resist roller 14 are provided along the transportation route TR. The resist roller 14 includes a metal roller 141 and a rubber roller 142. The paper discharging roller 15 is provided at the most downstream part of the transportation route TR. The paper discharging tray 16 is provided at the uppermost part of an image forming apparatus body 1a.

The toner image former 20 composes an image of four colors: yellow (Y), magenta (M), cyan (C), and black (K) in a so-called tandem system, and forms a toner image on the recording material M at a printing position ST. The toner image former 20 includes an intermediate transfer belt 20a. The toner image former 20 also includes a photoreceptor drum, a charging roller, an exposure apparatus, a development apparatus, a primary transfer roller, and a secondary transfer roller.

The fixing apparatus 21 fixes the toner image on the recording material M by gripping and transporting the recording material that carries the toner image along the transportation route TR.

The power supply 22 supplies power to each of the members in the image forming apparatus 1 under the control of the controller 40.

The operation input 23 receives operation input about print setting for the recording material M or operation of the image forming apparatus 1.

The controller 40 controls operation of the entire image forming apparatus 1. The controller 40 includes a central processing unit (CPU), a read only memory (ROM), and a random access memory (RAM). The CPU executes a control program. The ROM stores programs such as the control program. The RAM constitutes a work area of the CPU.

Each of the optical, ultrasonic, and paper thickness sensors 51, 52, and 53 is used for detecting a physical property of the recording material in different ways under the control of the controller 40. Although the physical property of the recording material detected with the optical, ultrasonic, and paper thickness sensors 51, 52, and 53 is the basis weight of the recording material here, other physical properties such as the thickness of the recording material may be detected. Detection positions of the optical, ultrasonic, and paper thickness sensors 51, 52, and 53 are on the more upstream side of the transportation route TR than that of the resist roller 14.

In the image forming apparatus 1, the paper feeding roller 12 feeds the recording material M stored in the paper feeding tray 11 to the transportation route TR one by one, and the transportation roller 13 and the resist roller 14 guide the recording material M to the printing position ST along the transportation route TR. In the image forming apparatus 1, the resist roller 14 once stops the recording material M, and transports the recording material M to the printing position ST according to the timing of printing with the toner image former 20.

Meanwhile, in the image forming apparatus 1, the toner image former 20 generates the toner image on the intermediate transfer belt 20a of the toner image former 20 in well-known electrophotographic and tandem systems, and rotation of the intermediate transfer belt 20a transports the toner image to the printing position ST. The resist roller 14 sends the recording material M to the printing position ST, and the toner image former 20 transports the toner image also to the printing position ST. The image forming apparatus 1 transfers the toner image from the intermediate transfer belt 20a to the recording material M at the printing position ST.

In the image forming apparatus 1, the fixing apparatus 21 heats and presses the recording material M on which the toner image is formed. This operation fixes the toner image on the recording material M. In the image forming apparatus 1, the paper discharging roller 15 then discharges the recording material M to the paper discharging tray 16.

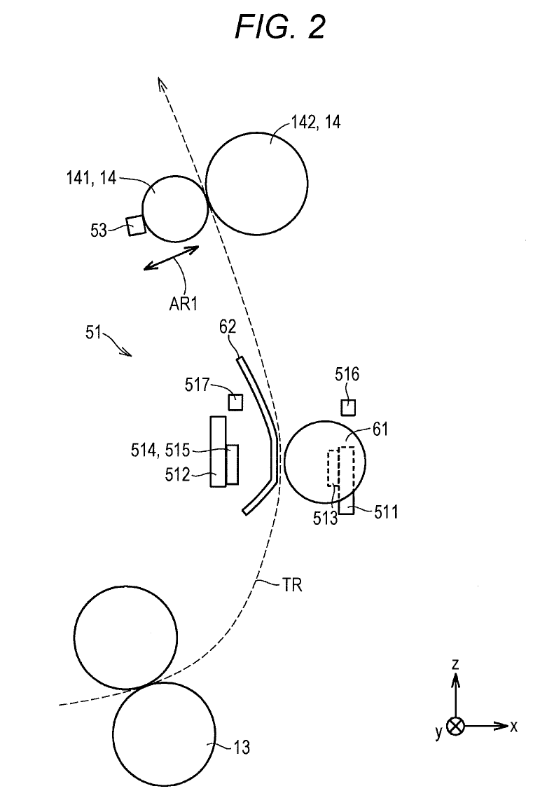

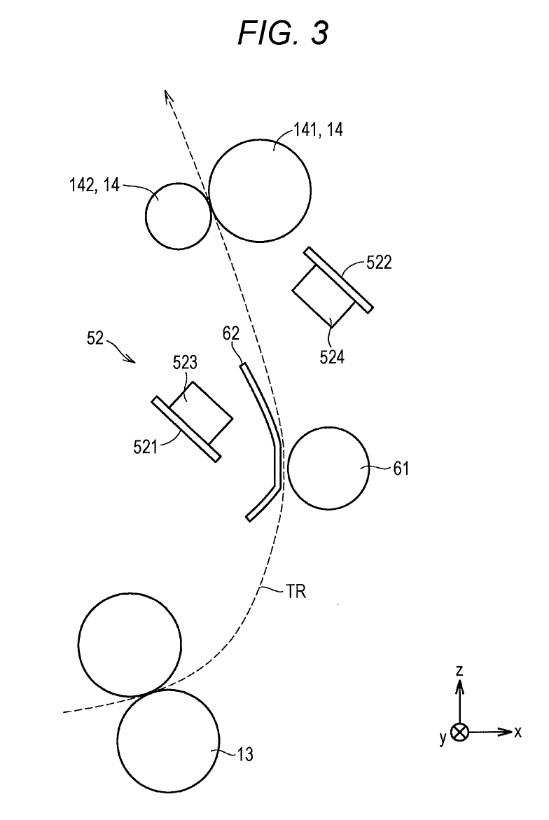

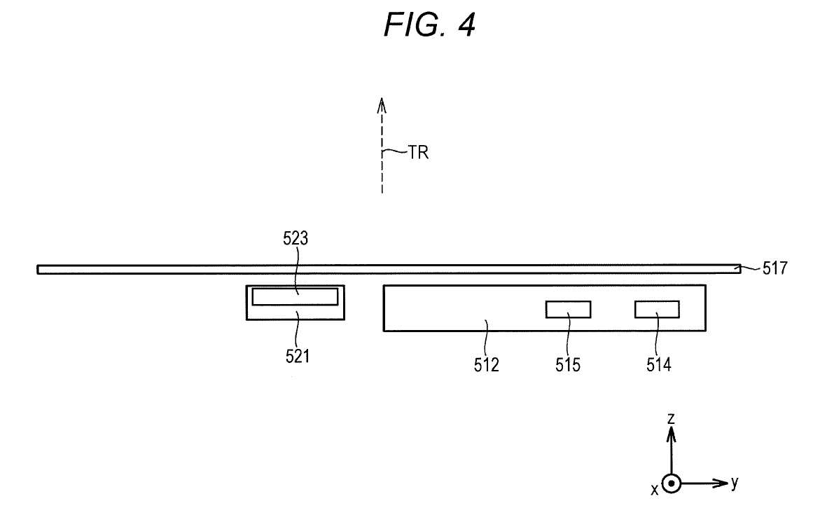

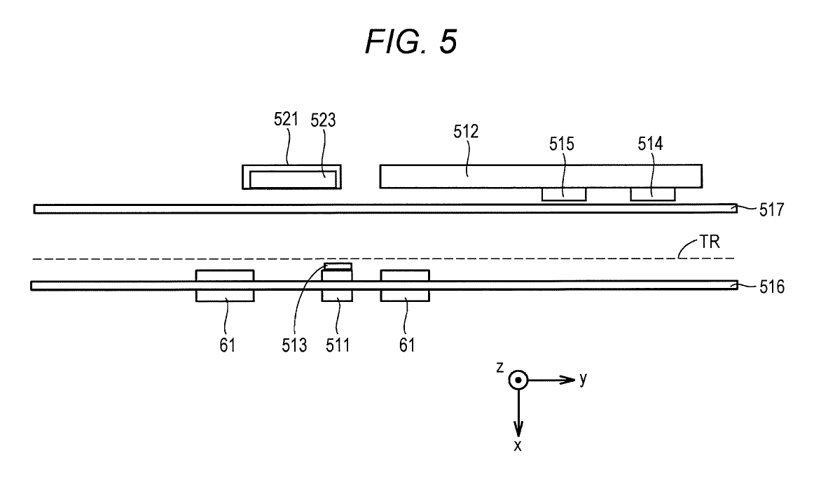

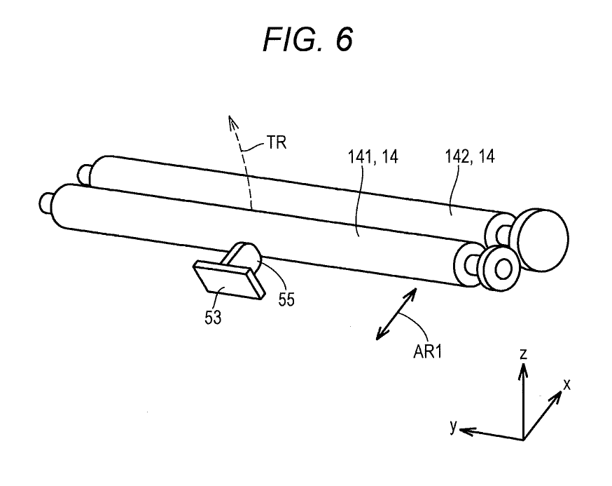

FIGS. 2 to 6 illustrate partial configurations of the optical, ultrasonic, and paper thickness sensors 51, 52, and 53 in one embodiment of the invention. FIG. 2 is a cross-sectional view taken along an xz plane at a first position in the y-axis direction. FIG. 3 is a cross-sectional view taken along the xz plane at a second position in the y-axis direction. FIG. 4 illustrates the vicinity of a substrate 512 as seen in the direction, from positive to negative, of the x-axis. FIG. 5 illustrates the vicinity of the substrate 512 as seen in the direction, from positive to negative, of the z-axis. FIG. 6 is a perspective view of the vicinity of the resist roller 14.

Referring to FIGS. 2 to 6, the image forming apparatus 1 further includes two rollers 61 and a guide 62. The two rollers 61 and the guide 62 face each other across the transportation route TR. The two rollers 61 are placed on the right side of the transportation route TR in FIG. 2. The two rollers 61 are arranged in the y-axis direction. The guide 62 is placed on the left side of the transportation route TR in FIG. 2. The recording material M fed by the paper feeding roller 12 is transported along the transportation route TR in the gap between the two rollers 61 and the guide 62 while the two rollers 61 and the guide 62 inhibit displacements of the recording material M in the thickness direction during transportation.

The optical sensor 51 outputs a voltage value corresponding to an amount of light that is transmitted through the recording material M at a position along the transportation direction of the recording material M. The optical sensor 51 also outputs a voltage value corresponding to an amount of light that is reflected through the recording material M. The optical sensor 51 includes a substrate 511, the substrate 512, light emitting elements 513 and 514, a light receiving element 515, and light guide plates 516 and 517.

The substrate 511 is placed between the two rollers 61 on the right side of the transportation route TR in FIG. 2. The light emitting element 513 is fixed on the surface, facing the transportation route TR, of the substrate 511. The substrate 512 is placed on the left side of the transportation route TR in FIG. 2. The light emitting element 514 and the light receiving element 515 are fixed on the surface, facing the transportation route TR, of the substrate 512.

The light guide plate 516 is provided in an upper part of the substrate 511 on the right side of the transportation route TR in FIG. 2. The light guide plate 516 extends in the y-axis direction, and guides light from the light emitting element 513 in the y-axis direction. The light guide plate 517 is provided in an upper part of the substrate 512 on the left side of the transportation route TR in FIG. 2. The light guide plate 517 extends in the y-axis direction, and guides light that is transmitted through the recording material M in the y-axis direction.

The ultrasonic sensor 52 outputs a voltage value corresponding to an amount of ultrasonic waves that are transmitted through the recording material M. The detection position of the ultrasonic sensor 52 is on the more downstream side of the transportation route TR than that of the optical sensor 51, and is on the more upstream side of the transportation route TR than that of the resist roller 14. The ultrasonic sensor 52 includes a transmission substrate 521, a reception substrate 522, a transmission sensor 523, and a reception sensor 524. The transmission substrate 521 is placed on the left side of the transportation route TR in FIG. 2. The substrate 512 and the transmission substrate 521 are arranged in the y-axis direction. The reception substrate 522 is placed on the right side of the transportation route TR in FIG. 2 obliquely upward from the transmission substrate 521. The transmission sensor 523 is fixed on the surface, facing the transportation route TR, of the transmission substrate 521. The reception sensor 524 is fixed on the surface, facing the transportation route TR, of the reception substrate 522.

The paper thickness sensor 53 is in contact with the metal roller 141. The metal roller 141 is movable in a direction AR1 perpendicular to the rotational axis of the metal roller 141. When the recording material M passes between the resist rollers 14, the metal roller 141 moves in response to the thickness of the recording material M. The paper thickness sensor 53 includes an actuator 55 (one example of displacement members) in contact with the metal roller 141, and outputs information on the thickness of the recording material M based on a displacement amount of the actuator 55 at the time when the recording material M passes between the resist rollers 14.

### Method of Detecting Basis Weight of Recording Material with Each of Sensors

A method of detecting the basis weight of the recording material with each of the optical, ultrasonic, and paper thickness sensors 51, 52, and 53 will now be described.

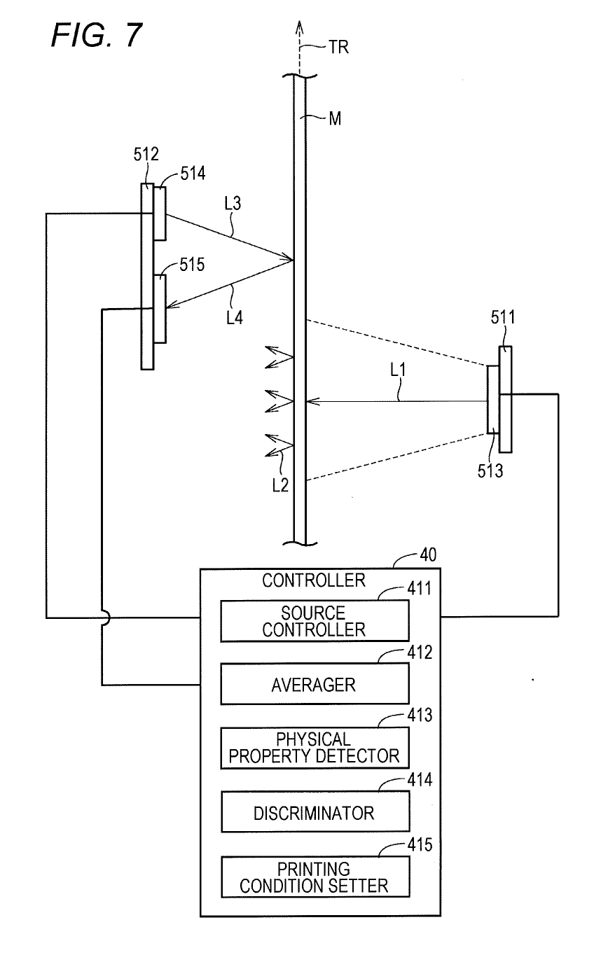

FIG. 7 illustrates a method of detecting the basis weight of the recording material M with the optical sensor 51 in one embodiment of the invention.

Referring to FIG. 7, the controller 40 includes a source controller 411, an averager 412 (one example of averagers), a physical property detector 413 (one example of detector), a discriminator 414 (one example of discriminators), and a printing condition setter 415. The optical sensor 51, the source controller 411, the averager 412, and the physical property detector 413 constitute a first physical property detector for detecting a physical property (here the transmittance and basis weight) of the recording material M based on an amount of light that is transmitted through the recording material M.

The light emitting element 514 sequentially applies light L3 to the recording material M under the control of the source controller 411. The light L3 for each of color of red (R), green (G), and blue (B), and turns to reflected light. The light receiving element 515 receives reflected light L4 reflected by the recording material M, and outputs a voltage value corresponding to an amount of the received reflected light to the controller 40. The physical property detector 413 detects the color tone of the recording material M based on the voltage value corresponding to the amount of the reflected light output by the light receiving element 515. Note that, to increase the amount of the reflected light, a white back plate may be provided behind a position, to which the light L3 is applied, of the recording material M.

The light emitting element 513 applies light L1 to the recoding material M under the control of the source controller 411. The light L1 has a property based on the color tone of the recording material M detected by the physical property detector 413, and is transmitted through the recording material M. The light emitting element 513 applies the light L1 at timing different from a light emitting timing of the light emitting element 514. The light receiving element 515 receives transmitted light L2 that is transmitted through the recording material M (mainly scattered light scattered by the recording material M), and outputs a voltage value corresponding to an amount of light, which is an amount of the transmitted light L2, at a position along the transportation direction of the recording material M to the controller 40.

The averager 412 calculates an average value obtained by averaging the voltage value output by the light receiving element 515. The physical property detector 413 detects the transmittance and basis weight of the recording material M based on the average value calculated by the averager 412.

As described later, the discriminator 414 discriminates the type of the recording material M by using one of detection results from the first, a second, and a third physical property detectors. In the embodiment, the discriminator 414 discriminates the type of the recording material M among plain paper, label paper, back paper, envelopes, and overhead projector (OHP) sheets.

As described later, the printing condition setter 415 sets a printing condition according to the discriminated type of the recording material M.

Plain paper is generally used in image forming apparatuses, and has both surfaces that are not printed. Label paper is a recording material that includes a material to the back of which an adhesive is deposited, and a mount to which the material is attached, and whose material is allowed to be attached to an object by peeling the material off the mount. Back paper is obtained by performing printing on only one surface of plain paper. Envelopes are obtained by stacking paper in a bag shape. OHP sheets are transparent films on which an image is to be drawn. The image serves as the base of an image to be projected with an overhead projector (OHP).

Incidentally, it is expected that basis weights of plain paper, back paper, and label paper can be measured. It is expected that envelopes and OHP sheets can be discriminated from other recording materials.

To inhibit deterioration of the accuracy in detecting the basis weight of the recording material M, a passing paper width (displacement of the recording material M in the thickness direction during transportation) at the detection position of the optical sensor 51 is preferably set in a range of ±1 mm to ±2 mm based on a position of the transportation route TR. In addition, the ratio of a distance d2 to a distance d1 (d1:d2) is preferably set to be 6:4. The distance d1 is from the light emitting element 513 to the recording material M. The distance d2 is from the light emitting element 514 to the recording material M. The averager 412 preferably averages voltage values obtained at ten or more detection positions, which are provided at 5 mm pitch in the recording material M. The optical sensor 51 requires positional stability of the recording material Mat the detection positions. The optical sensor 51 is required to secure accuracy for a wide range of light amount. The optical sensor 51 is preferably placed near the nip of an intermediate roller.

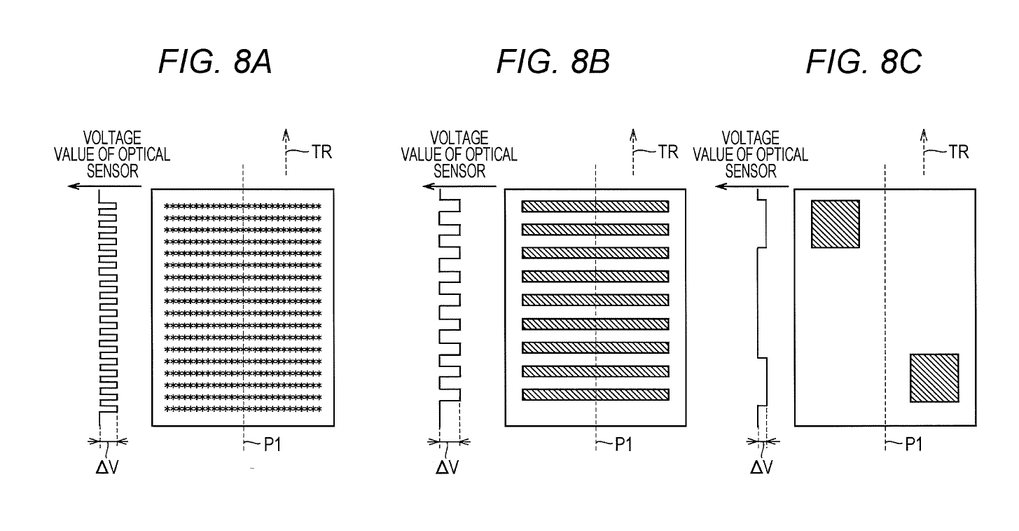

FIGS. 8A to 8C schematically illustrate various printing patterns of back paper. Note that, in FIGS. 8A to 8C, the voltage values output by the optical sensor 51 on detection of each sheet of the back paper are also indicated.

Referring to FIGS. 8A to 8C, when the light guide plate 516 is provided, the light L1 can be applied in a wide range of the recording material M along a width direction (lateral direction in FIGS. 8A to 8C). When the light guide plate 517 is provided, the transmitted light L2 is collected from the wide range of the recording material M along the width direction, and received by the light receiving element 515. This causes the voltage value output from the optical sensor 51 to correspond to an amount of light that is transmitted through the entire region in a direction perpendicular to the transportation direction of the recording material M (width direction). As a result, in addition to back paper with a printing pattern (symbol (*) or hatching part) on a center line P1 in the width direction of the recording material M as illustrated in FIGS. 8A and 8B, the optical sensor 51 can also detect back paper with a printing pattern on a part other than the center line P1 as illustrated in FIG. 8C.

When the recording material M is back paper, the voltage value of the optical sensor 51 is greatly decreased at a printed part. This causes a variation amount AV of the voltage value output from the optical sensor 51 in the recording material M to be greater than a predetermined amount VA. When the variation amount ΔV is greater than the predetermined amount VA, the discriminator 414 may determine that the recording material M is back paper without calculating the average value at the averager 412.

In addition, when back paper has been stored in the paper feeding tray 11 before the recording material M is stored in the paper feeding tray 11, the recording material M is also highly likely to be back paper. When back paper has been stored in the paper feeding tray 11 before the recording material M is stored in the paper feeding tray 11, and the variation amount ΔV of the voltage value of the optical sensor 51 is greater than a predetermined amount VB (the predetermined amount VB may be less than the predetermined amount VA), the discriminator 414 may determine that the recording material M is back paper without calculating the average value at the averager 412.

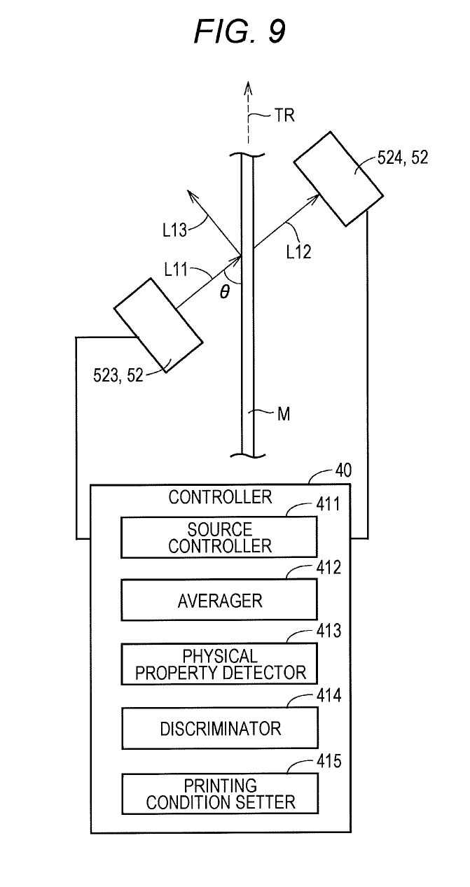

FIG. 9 illustrates a method of detecting the basis weight of the recording material M with the ultrasonic sensor 52 in one embodiment of the invention.

Referring to FIG. 9, the ultrasonic sensor 52, the source controller 411, and the physical property detector 413 constitute a second physical property detector for detecting the basis weight of the recording material M based on an amount of ultrasonic waves that are transmitted through the recording material M.

The transmission sensor 523 applies an ultrasonic wave L11 to the recording material M under the control of the source controller 411. Note that the ultrasonic wave L11 is required to be an electromagnetic wave having a wavelength different from that of the light L1.

The ultrasonic wave L11 is divided into an ultrasonic wave L12 and an ultrasonic wave L13. The ultrasonic wave L12 is transmitted through the recording material M. The ultrasonic wave L13 is reflected by the recording material M. The reception sensor 524 receives the ultrasonic wave L12 transmitted through the recording material M, and outputs a voltage value corresponding to an amount of the received ultrasonic waves to the controller 40.

The physical property detector 413 detects the basis weight of the recording material M based on the voltage value received from the reception sensor 524. The physical property detector 413 detects the basis weight of the recording material M based on the ratio (attenuation factor) of the crest value of the ultrasonic wave amount indicated by the voltage value that is output from the reception sensor 524 to that of the ultrasonic wave amount sent from the transmission sensor 523.

Note that envelopes include stacked paper, and have a property of not easily transmitting ultrasonic waves compared to plain paper. Consequently, when the ultrasonic wave amount indicated by the voltage value that is output from the reception sensor 524 (amount of ultrasonic waves that are transmitted through the recording material M) is lower than a predetermined ultrasonic-wave-amount threshold value TH, the discriminator 414 may determine that the recording material M is an envelope without depending on detection results on the basis weight from other sensors. In particular, an angle θ of a direction in which the ultrasonic wave L11 is applied by the transmission sensor 523 to the transportation route TR is preferably 38 to 45 degrees. In this angular range, the ultrasonic wave amount is remarkably decreased when the recording material is an envelope. Adopting the angular range thus can improve the accuracy in detecting envelopes.

To inhibit deterioration of the accuracy in detecting the basis weight of the recording material M, a passing paper width at the detection position of the ultrasonic sensor 52 is preferably set within 2.4 mm. This is because positional stability of the recording material M is required at the detection position of the ultrasonic sensor 52.

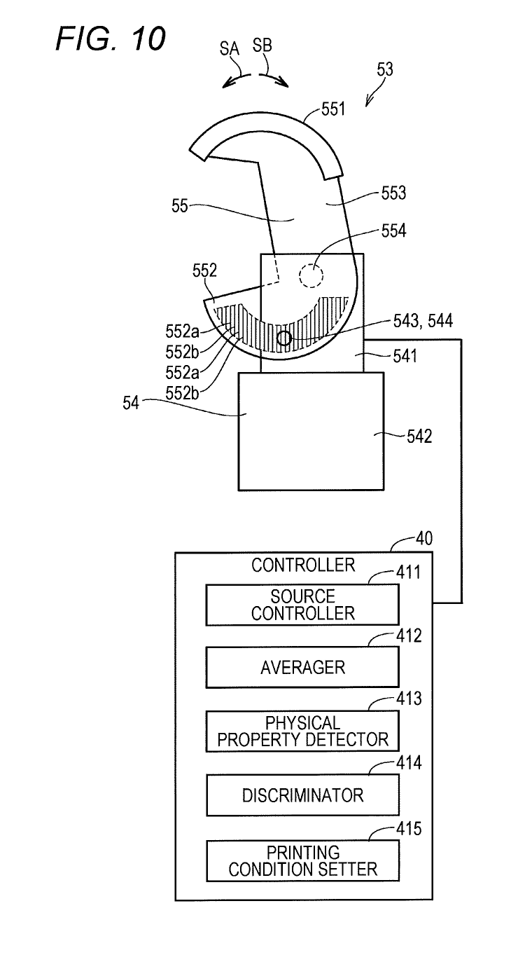

FIG. 10 illustrates a method of detecting the basis weight of the recording material M with the paper thickness sensor 53 in one embodiment of the invention.

Referring to FIG. 10, the paper thickness sensor 53 and the physical property detector 413 constitute a third physical property detector for detecting the basis weight of the recording material M based on a displacement amount of the actuator 55 at the time when the recording material M passes through the detection position of the actuator 55. Note that the first, second, and third physical property detectors detect the basis weight of the recording material M in different ways.

The paper thickness sensor 53 includes a sensor 54 and the actuator 55. The sensor 54 detects a movement amount of the actuator 55, and outputs information on the detected movement amount to the controller 40. The sensor 54 includes two supports 541, a base 542, an irradiator 543, and a light receiver 544. The actuator 55 is swingably supported between the two supports 541. The base 542 fixes the two supports 541. The irradiator 543 is provided inside one of the supports 541, and applies light to an encoder 552 of the actuator 55. The light receiver 544 is provided inside the other support 541, and receives light transmitted through the encoder 552 from the irradiator 543. The light receiver 544 outputs information corresponding to the amount of the received light to the controller 40.

The actuator 55 can move in both directions indicated by arrows SA and SB around a rotational shaft 554. The actuator 55 includes a contact part 551, the encoder 552, an arm 553, and the rotational shaft 554.

The contact part 551 is in contact with the metal roller 141. The contact part 551 has an arc shape.

The encoder 552 includes a plurality of high transmittance parts 552a and a plurality of low transmittance parts 552b. The transmittance of the high transmittance parts 552a is higher than that of the low transmittance parts 552b. Each of the plurality of high transmittance parts 552a and each of the plurality of low transmittance parts 552b are alternately arranged along the swinging direction of the actuator 55. This causes the transmittance of the encoder 552 at a portion where light is applied from the irradiator 543 to periodically change due to movements of the actuator 55. The arm 553 connects the contact part 551 and the encoder 552. This configuration integrally swings the contact part 551 and the encoder 552. The rotational shaft 554 is fixed near the boundary between the encoder 552 and the arm 553. The rotational shaft 554 extends in a thickness direction.

The physical property detector 413 detects the basis weight of the recording material M based on the information output from the light receiver 544.

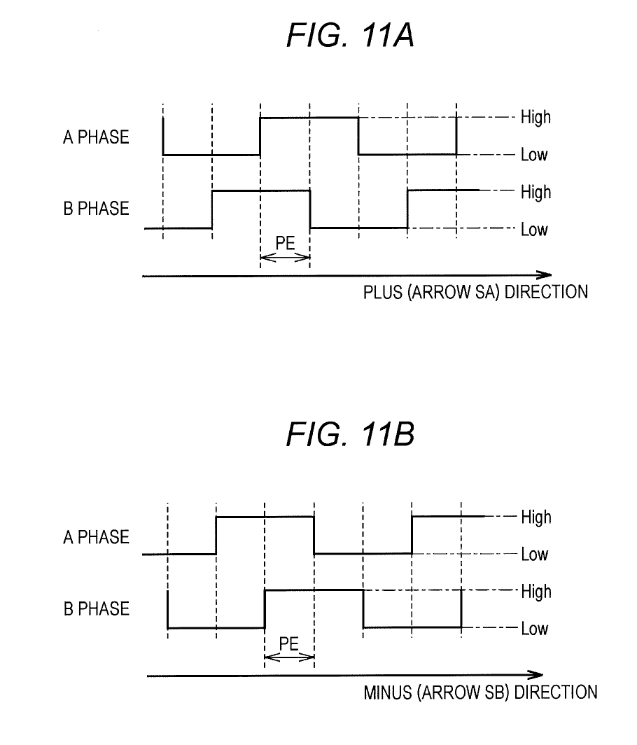

FIGS. 11A and 11B schematically illustrate information output by the sensor 54 in one embodiment of the invention. FIG. 11A illustrates an output from the sensor 54 at the time when the actuator 55 is moved in a plus direction (arrow SA direction). FIG. 11B illustrates an output from the sensor 54 at the time when the actuator 55 is moved in a minus direction (arrow SB direction).

Referring to FIGS. 11A and 11B, the light receiver 544 outputs two phases of an A phase and a B phase. Each of the A and B phases is a pulse. The phases in the movement direction of the actuator 55 (thickness direction of the recording material M) are shifted by 90 degrees. The thickness thus can be measured with resolution (accuracy) corresponding to a distance PE between the pulse edges. This resolution is, for example, 5 μm.

The transmittance of the encoder 552 at a portion where light is applied from the irradiator 543 periodically changes as the movement amount of the actuator 55 in the plus or minus direction increases. The amount of light received by the light receiver 544 of the sensor 54 also periodically changes as the movement amount of the actuator 55 increases. Consequently, as described above, each of the A and B phases turns to a pulse that repeats high (H) and low (L) states at intervals corresponding to twice the distance PE as the movement amount of the actuator 55 in the plus or minus direction increases.

Note that, to inhibit wear of the contact part 551, the paper thickness sensor 53 is required to be placed such that the contact part 551 is in indirect contact with the recording material M and displacements of the metal roller 141 accompanying passage of the recording material M are accurately transmitted to the actuator 55.

The optical, ultrasonic, and paper thickness sensors 51, 52, and 53 may detect the physical property of the recording material M being transported (moved) by a recording material transporter 10, and may detect the physical property of the recording material M once being stopped by the resist roller 14.

### Accuracy in Detecting Physical Property with Each of Sensors

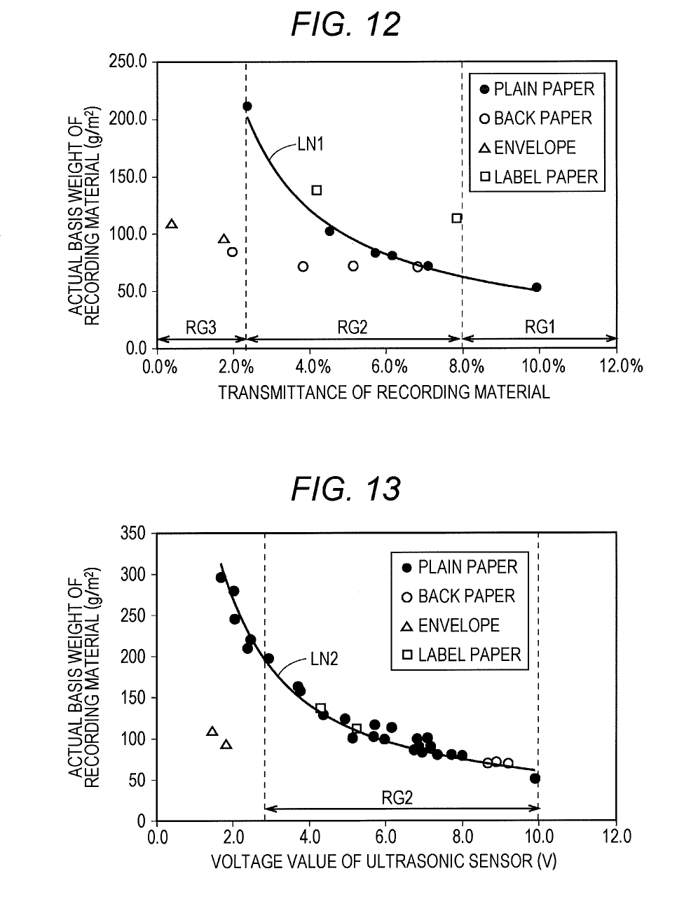

FIG. 12 is a graph illustrating the relation between the transmittance of light that is transmitted through the recording material detected by the optical sensor 51 in one embodiment of the invention and the actual basis weight of the recording material.

Referring to FIG. 12, the physical property detector 413 stores a curve LN1. The curve LN1 is a reference curve on two-axis coordinates. The reference curve indicates a change of a reference value of basis weight corresponding to the transmittance of light transmitted through the recording material (transmitted light L2) detected by the optical sensor 51 (hereinafter may be referred to as the transmittance of the recording material). The curve LN1 is calculated from a relation obtained in the case where the recording material is plain paper. The physical property detector 413 detects the transmittance of the recording material based on the amount of light that is transmitted through the recording material. The physical property detector 413 also detects the basis weight of the recording material by using the curve LN1 based on the detected transmittance of the recording material.

When the recording material is plain paper, points indicating the relation between the detected transmittance of the recording material and the actual basis weight of the recording material are positioned substantially on the curve LN1. In contrast, when the recording material is back paper, an envelope, or label paper, the points indicating the relation between the detected transmittance of the recording material and the actual basis weight of the recording material are alienated from the curve LN1.

Specifically, when the recording material is back paper or an envelope, the basis weight obtained from the curve LN1 based on the detected transmittance of the recording material is greater than the actual basis weight. This is because back paper has a printed part and thus light is not easily transmitted compared to plain paper. This is because envelopes include stacked paper and thus light is not easily transmitted compared to plain paper. When the recording material is label paper, the basis weight obtained from the curve LN1 based on the detected transmittance of the recording material is less than the actual basis weight. This is because label paper has a greater specific gravity than plain paper.

In addition, when the focus is on the accuracy in detecting the basis weight detected by using the curve LN1 based on transmittance, the followings are found. In the range where the transmittance of light transmitted through the recording material is more than 8.0% (range RG1), alienation of the points, which indicate the relation between the transmittance and the actual basis weight of the recording material, from the curve LN1 is small, and the accuracy in detecting the basis weight detected by using the curve LN1 is high. In the range where the transmittance of light transmitted through the recording material is 8.0% or less, alienation of the points, which indicate the relation between the transmittance and the actual basis weight of the recording material, from the curve LN1 is large, and the accuracy in detecting the basis weight detected by using the curve LN1 is low.

Note that, although not illustrated in the graph of FIG. 12, the light transmittance of an OHP sheet is extremely higher than those of, for example, plain paper, label paper, back paper, and an envelope (higher than a predetermined transmittance threshold value). This enables the optical sensor 51 to detect that the recording material is an OHP sheet.

FIG. 13 illustrates the relation between the voltage value output by the ultrasonic sensor 52 in one embodiment of the invention and the actual basis weight of the recording material.

Referring to FIG. 13, the physical property detector 413 stores a curve LN2. The curve LN2 is a reference curve indicating the relation between the voltage value output by the ultrasonic sensor 52 and the actual basis weight of the recording material. The curve LN2 is the reference curve calculated from a relation obtained in the case where the recording material is plain paper. The physical property detector 413 detects the basis weight of the recording material by using the curve LN2 based on the voltage value output by the ultrasonic sensor 52.

When the recording material is plain paper, label paper, or back paper, points indicating the relation between the voltage value and the actual basis weight of the recording material are positioned substantially on the curve LN2. In particular, when the recording material is back paper, printed parts have little influence on ultrasonic waves. In contrast, when the recording material is an envelope, the points indicating the relation between the voltage value and the actual basis weight of the recording material are alienated from the curve LN2. When the recording material is an envelope, the basis weight of the recording material detected by using the curve LN2 based on the voltage value is greater than the actual basis weight. This is because envelopes include stacked paper and ultrasonic waves are not easily transmitted compared to plain paper.

In addition, when the focus is on the accuracy in detecting the basis weight obtained by using the curve LN2 based on the voltage value, the followings are found. In the range where the voltage value is 2.8 V or more (range RG2), alienation of the points, which indicate the relation between the voltage value and the actual basis weight of the recording material, from the curve LN2 is small, and the detection accuracy for the basis weight detected by using the curve LN2 is high. In the range where the voltage value is less than 2.8 V, alienation of the points, which indicate the relation between the voltage value and the actual basis weight of the recording material, from the curve LN2 is large, and the accuracy in detecting the basis weight detected by using the curve LN2 is low. Here, the range where the voltage value is 2.8 V or more corresponds to the range where the light transmittance is 2.8% or more in the graph of FIG. 12 (range RG2).

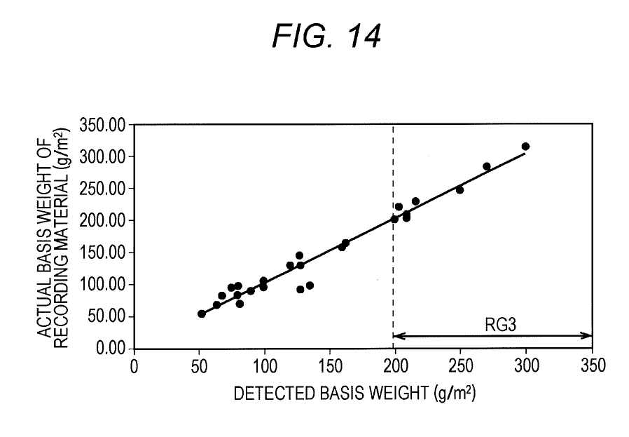

FIG. 14 is a graph illustrating the relation between the basis weight of the recording material detected by the paper thickness sensor 53 in one embodiment of the invention and the actual basis weight of the recording material.

Referring to FIG. 14, it is found that, in the range where the detected basis weight of the recording material is more than 200 g/m² (range RG3), alienation of the detected basis weight of the recording material from the actual basis weight of the recording material is small, and the accuracy in detecting the basis weight detected by the paper thickness sensor 53 is high. It is found that, in the range where the detected basis weight of the recording material is 200 g/m² or less, alienation of the detected basis weight of the recording material from the actual basis weight of the recording material is large, and the accuracy in detecting the basis weight detected by the paper thickness sensor 53 is low. Here, the range where the detected basis weight of the recording material is more than 200 g/m² corresponds to the range where the light transmittance is less than 2.8% in the graph of FIG. 12 (range RG3).

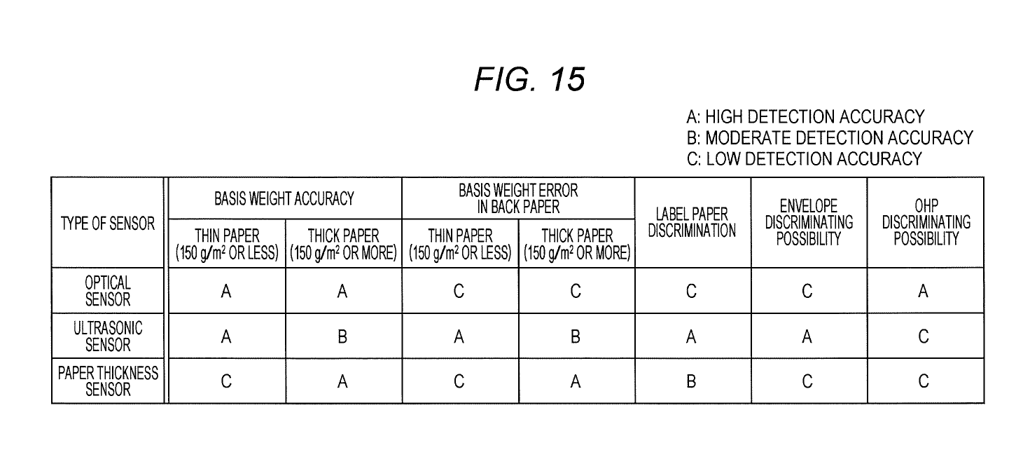

FIG. 15 illustrates the detection accuracy of each of the optical, ultrasonic, and paper thickness sensors 51, 52, and 53 for various recording materials.

Referring to FIG. 15, the optical sensor 51 has high accuracy in detecting the basis weight of thin plain paper (basis weight: 150 g/m² or less), detecting the basis weight of thick plain paper (basis weight: 150 g/m² or more), and discriminating OHP sheets. The ultrasonic sensor 52 has high accuracy in detecting the basis weight of thin back paper (basis weight: 150 g/m² or less), discriminating label paper, and discriminating envelopes. The paper thickness sensor 53 has high accuracy in detecting the basis weight of thick plain paper (basis weight: 150 g/m² or more) and detecting the basis weight of thick back paper (basis weight: 150 g/m² or more).

### Method of Discriminating Type of Recording Material

As described above, types of sensors capable of detecting basis weight with high accuracy are different depending on the transmittance of a recording material. For this reason, in the embodiment, when the transmittance of a recording material is within a first range, the discriminator 414 discriminates the type of the recording material by using a detection result from the first physical property detector, and when the transmittance of the recording material is within a second range different from the first range, the discriminator 414 discriminates the type of the recording material by using a detection result from the second physical property detector.

In addition, when the transmittance of the recording material is within the first range, the discriminator 414 identifies the physical property of the recording material with the first physical property detector and when the transmittance of the recording material is within the second range, the discriminator 414 identifies the physical property of the recording material with the second physical property detector. The discriminator 414 discriminates the type of a target recording material based on the state of alienation of the identified physical property from a reference value.

In addition, when the transmittance of the target recording material is within a third range different from the first and second ranges, the discriminator 414 may discriminate the type of the target recording material by using a detection result from the third physical property detector.

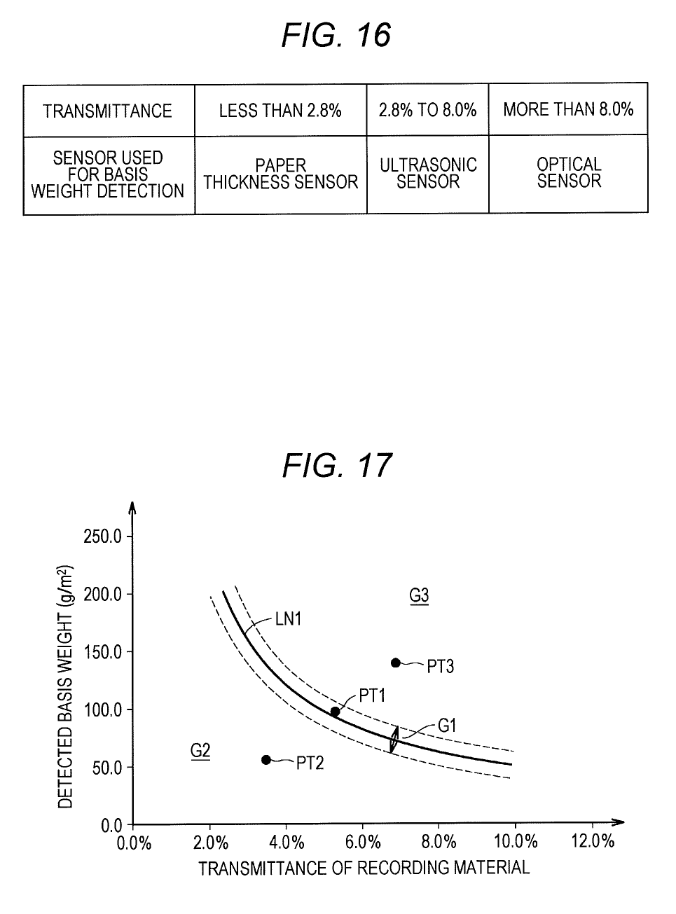

FIG. 16 illustrates a combination of the transmittance of the recording material in one embodiment of the invention and the sensors used for basis weight detection.

Referring to FIGS. 12 and 16, when the transmittance of the recording material detected by the optical sensor 51 is within the range RG1 (one example of the first range) greater than 8.0% (one example of a first threshold value), the discriminator 414 identifies (detects) the basis weight of the recording material by using only the optical sensor 51 from the optical, ultrasonic, and paper thickness sensors 51, 52, and 53 (by using only the voltage value output by the optical sensor 51).

When the transmittance of the recording material detected by the optical sensor 51 is within the range RG2 (one example of the second range) from 2.8% (one example of a second threshold value) to 8.0%, the discriminator 414 identifies (detects) the basis weight of the recording material by using only the ultrasonic sensor 52 from the optical, ultrasonic, and paper thickness sensors 51, 52, and 53 (by using only the voltage value output by the ultrasonic sensor 52).

When the transmittance of the recording material detected by the optical sensor 51 is within the range RG3 (one example of the third range) less than 2.8%, the discriminator 414 identifies (detects) the basis weight of the recording material by using only the paper thickness sensor 53 from the optical, ultrasonic, and paper thickness sensors 51, 52, and 53 (by using only the information output by the paper thickness sensor 53).

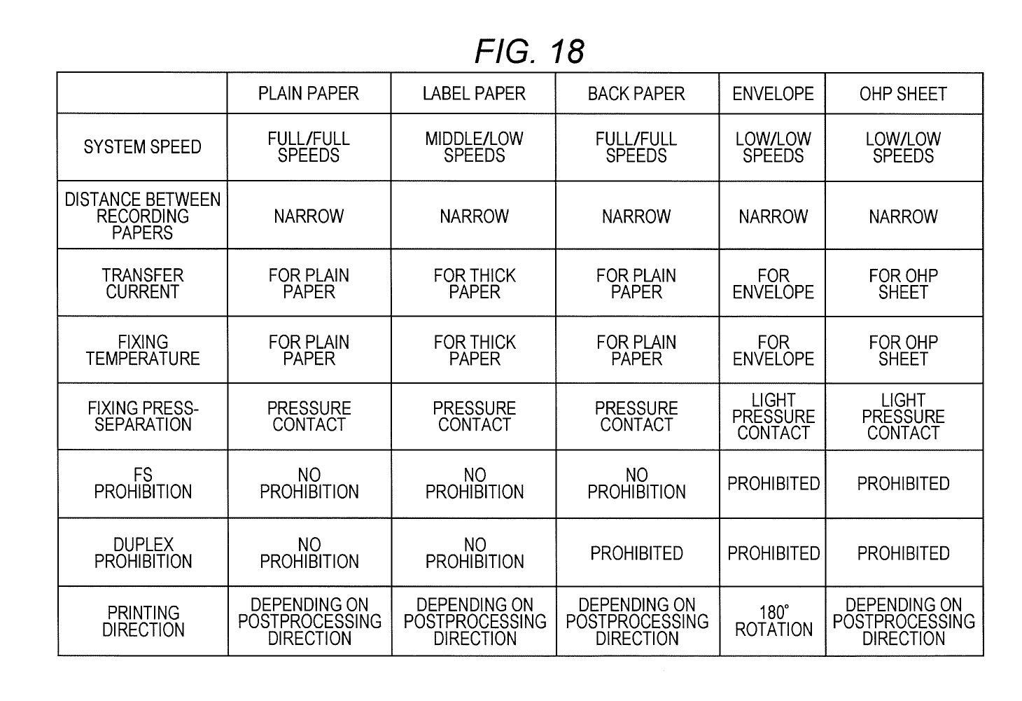

FIG. 17 is a graph illustrating a method of discriminating the type of the recording material in one embodiment of the invention. In the graph, the vertical axis represents the detected basis weight, and the horizontal axis represents the transmittance of the recording material.

Referring to FIG. 17, the discriminator 414 then discriminates the type of a recording material based on the state of alienation of the identified physical property from a reference value. The discriminator 414 plots a point indicating the transmittance of the recording material and the detected basis weight (for example, points PT1 to PT3) on two-axis coordinates. The discriminator 414 discriminates the type of the recording material among plain paper, label paper, and back paper based on the state of alienation of the plotted point from the curve LN1.

Specifically, when the plotted point is within a region G1 that is not alienated from the curve LN1 (when the plotted point is, for example, the point PT1), the discriminator 414 determines that the type of the recording material is plain paper. This is because, when the recording material is plain paper, the actual basis weight is substantially the same as the basis weight detected by the optical sensor 51, as indicated in FIG. 12.

In addition, when the plotted point is within a region G2 that is alienated downward from the curve LN1 (when the plotted point is, for example, the point PT2), the discriminator 414 determines that the type of the recording material is back paper. This is because, when the recording material is back paper, the actual basis weight is less than the basis weight detected by the optical sensor 51, as indicated in FIG. 12.

Furthermore, when the plotted point is within a region G3 that is alienated upward from the curve LN1 (when the plotted point is, for example, the point PT3), the discriminator 414 determines that the type of the recording material is label paper. This is because, when the recording material is label paper, the actual basis weight is greater than the basis weight detected by the optical sensor 51, as indicated in FIG. 12.

### Method of Determining Printing Condition

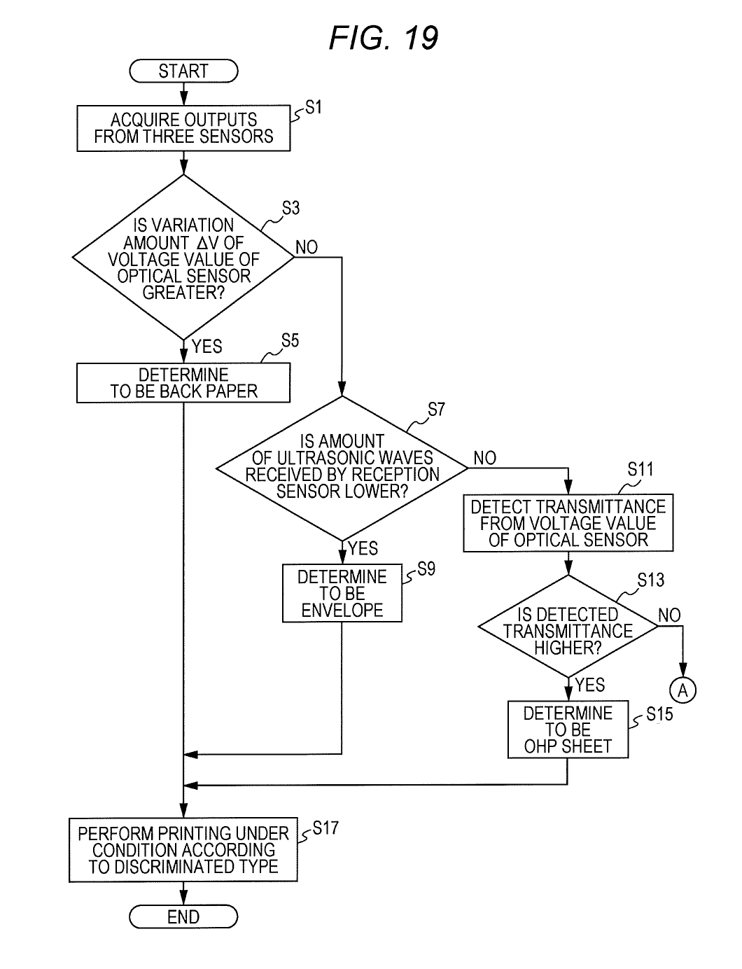

FIG. 18 schematically illustrates a setting table in one embodiment of the invention.

Referring to FIG. 18, the printing condition setter 415 sets a printing condition according to the discriminated type of the recording material by using the setting table.

Printing conditions are described in the setting table. The printing conditions are set when the discriminated type of the recording material is plain paper, label paper, back paper, an envelope, and an OHP sheet. The printing conditions include items of system speeds (printing speeds), distances between recording materials, transfer currents, fixing temperatures, fixing press-separation (pressure contact state between a fixation member and a pressure member), finisher (FS) prohibition (prohibition relating to postprocessing), duplex prohibition (prohibition of duplex printing), and printing directions.

When the recording material is back paper, duplex printing is prohibited since a character has already been printed on the back surface. In addition, when the recording material is label paper, switching the system speed between a middle speed and a low speed (setting a value different from the system speed in the case where the recording material is plain paper (slow-speed value)) efficiently transfers fixing heat to the recording material.

Note that the printing condition in FIG. 18 is one example, and any printing condition is set according to the type of recording material. The printing condition setter 415 preferably sets the system speed in the case where the recording material is determined to be label paper to a value different from the printing speed in the case where the recording material is determined to be plain paper (value lower than the printing speed in the case of being determined to be plain paper). In addition, when the recording material is determined to be back paper, the printing condition setter 415 preferably prohibits duplex printing, and does not receive setting for duplex printing through the operation input 23.

Note that the printing condition setter 415 may set a printing condition according to the basis weight of the recording material in addition to the type of the recording material.

### Flowchart

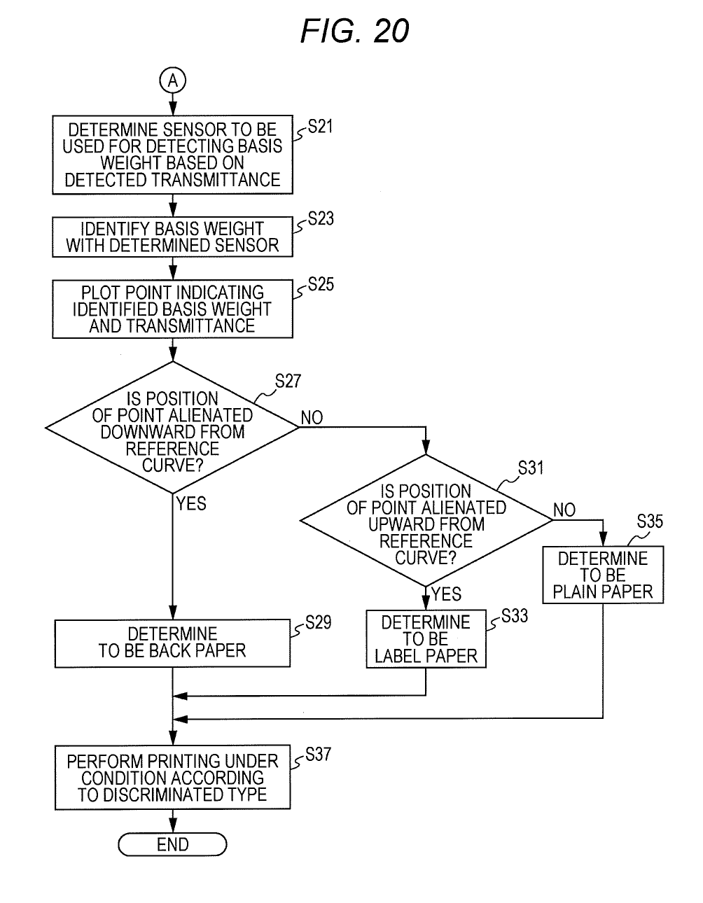

FIGS. 19 and 20 are flowcharts illustrating an operation of the image forming apparatus 1 in one embodiment of the invention.

Referring to FIG. 19, when feeding of the recording material is started, the controller 40 acquires outputs from each of the optical, ultrasonic, and paper thickness sensors 51, 52, and 53 (S1). The controller 40 then determines whether the variation amount ΔV of the voltage value output from the optical sensor 51 is greater than a predetermined amount (S3).

When the variation amount ΔV of the voltage value output from the optical sensor 51 is determined to be greater than the predetermined amount in Step S3 (YES in S3), the controller 40 determines that the recording material is back paper (S5). The controller 40 performs printing on the recording material with the toner image former 20 under a printing condition according to the determined type of the recording material (S17), and terminates processing.

When the variation amount ΔV of the voltage value output from the optical sensor 51 is determined to be not greater than the predetermined amount in Step S3 (NO in S3), the controller 40 determines whether the ultrasonic wave amount indicated by the voltage value that is output from the reception sensor 524 is lower than a predetermined ultrasonic-wave-amount threshold value (S7).

When the ultrasonic wave amount indicated by the voltage value that is output from the reception sensor 524 is determined to be lower than the predetermined ultrasonic-wave-amount threshold value in Step S7 (YES in S7), the controller 40 determines that the recording material is an envelope (S9). The controller 40 performs printing on the recording material with the toner image former 20 under a printing condition according to the determined type of the recording material (S17), and terminates processing.

When the ultrasonic wave amount indicated by the voltage value that is output from the reception sensor 524 is determined to be not lower than the predetermined ultrasonic-wave-amount threshold value in Step S7 (NO in S7), the controller 40 detects the transmittance of the recording material with the optical sensor 51 (S11), and determines whether the detected transmittance is higher than a predetermined transmittance threshold value (S13).

When the detected transmittance is determined to be higher than the predetermined transmittance threshold value in Step S13 (YES in S13), the controller 40 determines that the recording material is an OHP sheet (S15). The controller 40 performs printing on the recording material with the toner image former 20 under a printing condition according to the determined type of the recording material (S17), and terminates processing.

When the detected transmittance is determined to be not greater than the predetermined transmittance threshold value in Step S13 (NO in S13), the controller 40 proceeds to the processing of Step S21 in FIG. 20.

Referring to FIG. 20, in step S21, the controller 40 determines a sensor to be used for basis weight detection based on the detected transmittance (S21). The controller 40 then identifies the basis weight from an output value of the determined sensor (S23), and plots a point indicating the transmittance of the recording material and the identified basis weight (S25). The controller 40 then determines whether the position of the point is alienated downward from the curve LN1 (S27).

When the position of the point is determined to be alienated downward from the curve LN1 in Step S27 (YES in S27), the controller 40 determines that the recording material is back paper (S29). The controller 40 performs printing on the recording material with the toner image former 20 under a printing condition according to the discriminated type of the recording material (S37), and terminates processing.

When the position of the point is determined to be not alienated downward from the curve LN1 in Step S27 (NO in S27), the controller 40 determines whether the position of the point is alienated upward from the curve LN1 (S31).

When the position of the point is determined to be alienated upward from the curve LN1 in Step S31 (YES in S31), the controller 40 determines that the recording material is label paper (S33). The controller 40 performs printing on the recording material with the toner image former 20 under a printing condition according to the discriminated type of recording material (S37), and terminates processing.

When the position of the point is determined to be not alienated upward from the curve LN1 in Step S31 (NO in S31), the controller 40 determines that the recording material is plain paper (S35). The controller 40 performs printing on the recording material with the toner image former 20 under a printing condition according to the discriminated type of recording material (S37), and terminates processing.

### Effect of Embodiment

In the embodiment, the type of a target recording material is discriminated by using a detection result from a physical property detector according to the transmittance of the recording material, whereby, for example, back paper and label paper can be detected, and the accuracy in discriminating the type of the recording material can be improved.

### Others

The recording material discriminating apparatus of the invention may be any apparatus that, when the transmittance of the recording material is within the first range, discriminates the type of the recording material by using a detection result from the first physical property detector, and when the transmittance of the material is within the second range different from the first range, discriminates the type of the recording material by using a detection result from the second physical property detector. Each of the first and second physical property detectors can take any method of detection. In addition to methods of detection by using an amount of light or ultrasonic waves that are transmitted through the recording material, methods of detection by using reflectance of light that is reflected by the recording material, and methods of detection by using a displacement amount of a displacement member at the time when the recording material passes through the detection position of the displacement member may be used. The recording material discriminating apparatus of the invention preferably discriminates the type of the recording material among at least a part of options of plain paper, label paper, back paper, envelopes and OHP sheets.

Software or a hardware circuit may perform processing in the above-described embodiment. In addition, programs that execute processing in the above-described embodiment can be provided. The programs may also be provided to users after being recorded in recording media such as CD-ROMs, flexible disks, hard disks, ROMs, RAMs, and memory cards. Computers such as CPUs execute the programs. In addition, the programs may be downloaded to apparatuses through communication lines such as the Internet.

Although embodiments of the present invention have been described and illustrated in detail, the disclosed embodiments are made for purposes of illustration and example only and not limitation. The scope of the present invention should be interpreted by terms of the appended claims, and all changes which come within the meaning and range of equivalency of the claim are intended to be embraced therein.

What is claimed is:

1. A recording material discriminating apparatus comprising:
a hardware processor that:
detects a physical property of a recording material in different ways; and
when transmittance of the recording material is within a first range, discriminates a type of the recording material by using a detection result from the hardware processor, and when the transmittance of the recording material is within a second range different from the first range, discriminates the type of the recording material by using a detection result from the hardware processor.

2. The recording material discriminating apparatus according to claim 1,
wherein the hardware processor includes:
an identificator that, when the transmittance of the recording material is within the first range, identifies a physical property of the recording material with the hardware processor, and when the transmittance of the recording material is within the second range, identifies the physical property of the recording material with the hardware processor; and
a type discriminator that discriminates the type of the recording material based on alienation state of the physical property identified by the identificator from a reference value.

3. The recording material discriminating apparatus according to claim 2,
wherein the type discriminator discriminates the type of the recording material among at least plain paper and label paper, and
the label paper is a recording material that includes a material to a back of which an adhesive is deposited, and a mount to which the material is attached, and whose material is allowed to be attached to an object by peeling the material off the mount.

4. The recording material discriminating apparatus according to claim 2,
wherein the hardware processor further includes a plotter that plots a point indicating the transmittance of the recording material and the physical property identified by the identificator on two-axis coordinates, and
the type discriminator discriminates the type of the recording material based on alienation state of the point plotted by the plotter from a reference curve on the two-axis coordinates, the reference curve indicating a change in the reference value corresponding to a change in the transmittance of the recording material.

5. The recording material discriminating apparatus according to claim 1,
wherein the hardware processor detects the physical property of the recording material based on an amount of light that is transmitted through the recording material, and
the hardware processor detects the physical property of the recording material based on an amount of an ultrasonic wave that is transmitted through the recording material.

6. The recording material discriminating apparatus according to claim 5,
wherein the first range is greater than a first threshold value, and
the second range is less than the first threshold value.

7. The recording material discriminating apparatus according to claim 6,
wherein the hardware processor includes a displacement member, and detects the physical property of the recording material based on a displacement amount of the displacement member at a time when the recording material passes through a detection position of the displacement member,
when the transmittance of the recording material is within a third range different from the first and second ranges, the hardware processor discriminates the type of the recording material by using a detection result from the third physical property detector, and
the second range is greater than a second threshold value that is less than the first threshold value, and the third range is less than the second threshold value.

8. The recording material discriminating apparatus according to claim 5,
wherein the hardware processor includes
an outputter that outputs a voltage value corresponding to an amount of light that is transmitted through the recording material at a position along a transportation direction of the recording material,
the hardware processor calculates an average value obtained by averaging the voltage value output by the outputter,
the hardware processor further includes
a detector that detects the physical property of the recording material based on the average value calculated by the hardware processor,
when a variation amount of the voltage value output by the outputter is greater than a predetermined amount, the hardware processor determines that the recording material is back paper without calculating an average value at the hardware processor, and
the back paper is plain paper only one surface of which is printed.

9. The recording material discriminating apparatus according to claim 8,
wherein the outputter outputs a voltage value corresponding to an amount of light that is transmitted through an entire region in a direction perpendicular to the transportation direction of the recording material.

10. The recording material discriminating apparatus according to claim 8, further comprising a storage that stores a recording material,
wherein, when back paper has been stored in the storage before the recording material is stored and the variation amount of the voltage value output by the outputter is greater than a predetermined amount, the hardware processor determines that the recording material is the back paper without calculating an average value at the hardware processor.

11. The recording material discriminating apparatus according to claim 5,
wherein, when an amount of an ultrasonic wave that is transmitted through the recording material is less than a predetermined ultrasonic-wave-amount threshold value, the hardware processor determines that the recording material is an envelope.

12. An image forming apparatus comprising:
the recording material discriminating apparatus according to claim 1; and
a printer that performs printing on the recording material under a printing condition according to the type of the recording material discriminated by the hardware processor.

13. The image forming apparatus according to claim 12,
wherein the printer sets a printing speed of the recording material in a case where the hardware processor determines that the recording material is label paper at a value different from a printing speed of the recording material in a case where the hardware processor determines that the recording material is plain paper.

14. The image forming apparatus according to claim 12, further comprising a resist roller that transports the recording material to a printing position of the printer according to a timing of printing with the printer,
wherein detection position of the hardware processor is on a more upstream side of a transportation route of the recording material than that of the resist roller.

15. The image forming apparatus according to claim 12, further comprising a receptor that receives print setting for the recording material,
wherein, when the hardware processor determines that the recording material is back paper, the receptor does not receive setting for duplex printing.

16. A method of controlling a recording material discriminating apparatus including a hardware processor that detects a physical property of a recording material in different ways, the method comprising,
when transmittance of the recording material is within a first range, discriminating a type of the recording material by using a detection result from the hardware processor, and when the transmittance of the recording material is within a second range different from the first range, discriminating the type of the recording material by using a detection result from the hardware processor.
